(19) United States
(12) Patent Application Publication
(10) Pub. No.: US 2015/0321841 A1
(43) Pub. Date: Nov. 12, 2015

(54) TRASH RECEPTACLE WITH A BAG DISPENSING STORAGE COMPARTMENT

(71) Applicants: ANTHONY RAY SALAS, Henderson, NV (US); Abel Guerra Arteaga, Henderson, NV (US)

(72) Inventors: ANTHONY RAY SALAS, Henderson, NV (US); Abel Guerra Arteaga, Henderson, NV (US)

(21) Appl. No.: 14/271,081

(22) Filed: May 6, 2014

(51) Int. Cl. B65F 1/06; B65F 1/14

(52) U.S. Cl. CPC B65F 1/062; B65F 1/067; B65F 1/14; B65F 1/1646

(57) ABSTRACT

A trash receptacle to store and dispense bags for use with the receptacle includes a container comprising a cavity and a door pivotably mounted to a front face of the container, a compartment housed within the bottom portion of the container and having a dispensing port on a top face of the compartment, a shelf slidably mounted to the compartment and able to adjust to a first position outside of the container when the door is in an open position and a second position within the compartment when the door is in a closed position, and a storage unit disposed within the shelf and having an aperture on a top face of the storage unit. The storage unit stores bags to enable a user to remove one of the bags through the storage unit aperture and compartment dispensing port for placement within the container cavity.

### BACKGROUND

The embodiments herein relate generally to trash receptacles. More specifically, embodiments of the invention relate to a trash receptacle with a compartment to store bags.

Trash receptacles are used to collect waste items such as food, mixed plastics, paper products, or the like. Typically, a trash bag is placed within the receptacle to collect the waste so that a user can easily remove the bag to dispose the waste in an alternate location such as a trash can, dumpster, chute, or the like. Trash bags also prevent the waste items from settling in the receptacle, which can promote the decay of waste and growth of bacteria.

Currently, trash bags are purchased and stored in a cabinet, pantry, drawer, garage, or alternative storage location. This is inconvenient and/or problematic because a user has to retrieve a trash bag from the storage location to place within the trash receptacle. The storage location may be located far away from the trash receptacle or the user may not remember where the trash bags are being stored.

As such, there is a need in the industry for a trash receptacle with a bag dispensing storage compartment. This conveniently places the trash bags in the same location as the receptacle and reduces the burden on the user.

### SUMMARY

A trash receptacle is configured to store and dispense bags for use with the receptacle to collect trash. The trash receptacle comprises a container comprising a cavity and a door pivotably mounted to a front face of the container, a compartment housed within the bottom portion of the container and comprising a dispensing port on a top face of the compartment, a shelf slidably mounted to the compartment and configured to adjust to a first position outside of the container when the door is in an open position and a second position within the compartment when the door is in a closed position, and a storage unit disposed within the shelf and comprising an aperture on a top face of the storage unit, wherein the storage unit is configured to store a plurality of bags to enable a user to remove one of the plurality of bags through the storage unit aperture and the compartment dispensing port for placement within the container cavity, thereby allowing the collection of the trash.

### BRIEF DESCRIPTION OF THE FIGURES

The detailed description of some embodiments of the invention will be made below with reference to the accompanying figures, wherein the figures disclose one or more embodiments of the present invention.

FIG. 1 depicts a perspective view of certain embodiments of the trash receptacle;

FIG. 2 depicts a perspective view of certain embodiments of the trash receptacle with the upper portion of the receptacle hidden for illustrative clarity;

FIG. 3 depicts a perspective view of certain embodiments of the trash receptacle depicting the bottom compartment door in an open configuration;

FIG. 4 depicts a perspective view of certain embodiments of the trash receptacle depicting shelf 26 in an extended configuration;

FIG. 5 depicts a perspective view of certain embodiments of the trash receptacle depicting shelf 26 in an extended configuration and omitting bag storage unit 18;

FIG. 6 depicts an exploded view of certain embodiments of the trash receptacle;

FIG. 7 depicts a section view of certain embodiments of the trash receptacle along line 7-7 in FIG. 2;

FIG. 8 depicts a section view of certain embodiments of the trash receptacle depicting a partial extension of bag 20; and

FIG. 9 depicts a section view of certain embodiments of the trash receptacle depicting a full extension of bag 20.

### DETAILED DESCRIPTION OF CERTAIN EMBODIMENTS

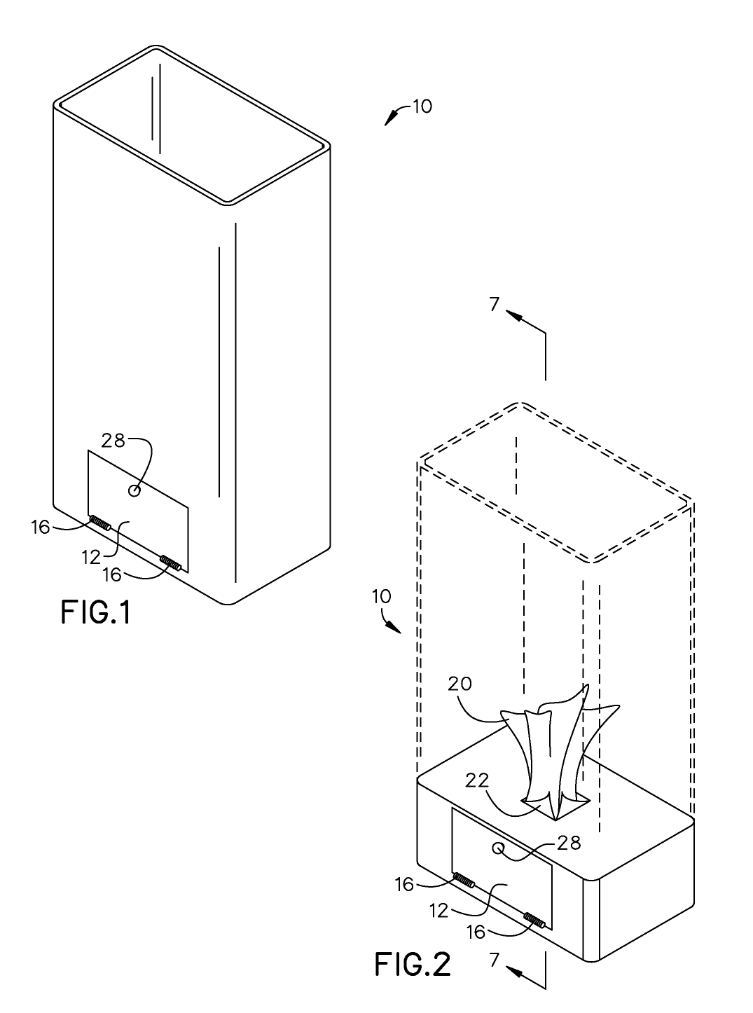

As depicted in FIGS. 1-4, trash receptacle 10 is configured to store bags 20 within bottom compartment 14. Trash receptacle 10 is depicted as having a rectangular shape. However, it shall be appreciated that trash receptacle 10 may have any alternative shape such as a cylinder. Trash receptacle 10 comprises bottom compartment door 12 and compartment door handle 28. In a preferred embodiment, compartment door 12 is pivotably mounted to trash receptacle 10 by spring hinges 16. While the figures depict spring hinges 16 external to trash receptacle 10, it shall be appreciated that spring hinges 16 may alternatively be positioned within the interior of the receptacle. However, any alternative fastening components known in the field may be used. Bags 20 are dispensed through an opening in bottom compartment 14, which has rubber flaps 22. Rubber flaps 22 secure a bag 20 that extends through the bottom compartment opening. This allows a user to easily remove a single bag 20 from bottom compartment 14. Any number of flaps 22 may be affixed to the bottom compartment opening.

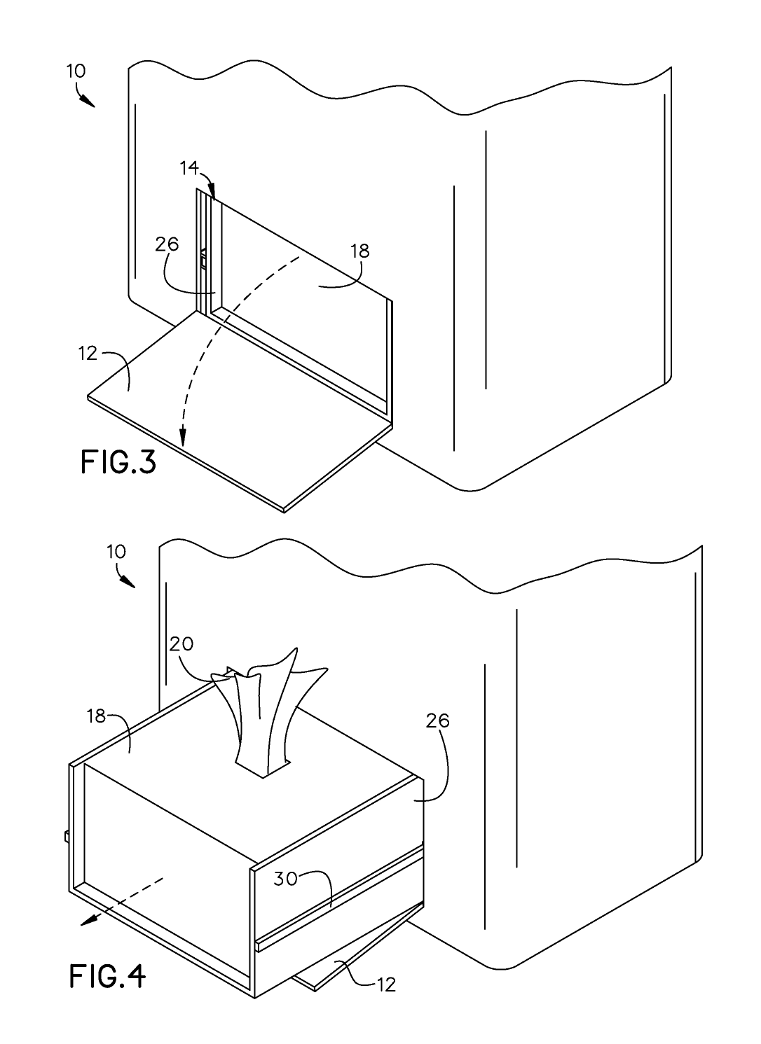

Trash receptacle 10 further comprises bag storage unit 18, which is disposed on shelf 26. Bag storage unit 18 comprises an aperture on the top face of the unit to allow bags 20 to be removed from the unit. Bags 20 may be stored within bag storage unit 18 in any manner. For example, the bags may be wound up in a roll or folded on top of one another. In both cases, bags 20 are perforated to allow a user to separate a single bag from the remaining bags. As depicted in FIGS. 3-4, bottom compartment door 12 may be adjusted to an open position to allow a user to slide shelf 26 and bag storage unit 18 outside of trash receptacle 10. This allows a user to refill bags 20 within bag storage unit 18 if necessary. Once completed, the user can slide bag storage unit 18 and shelf 26 back inside of bottom compartment 14. This allows bottom compartment door 12 to swing to a closed position.

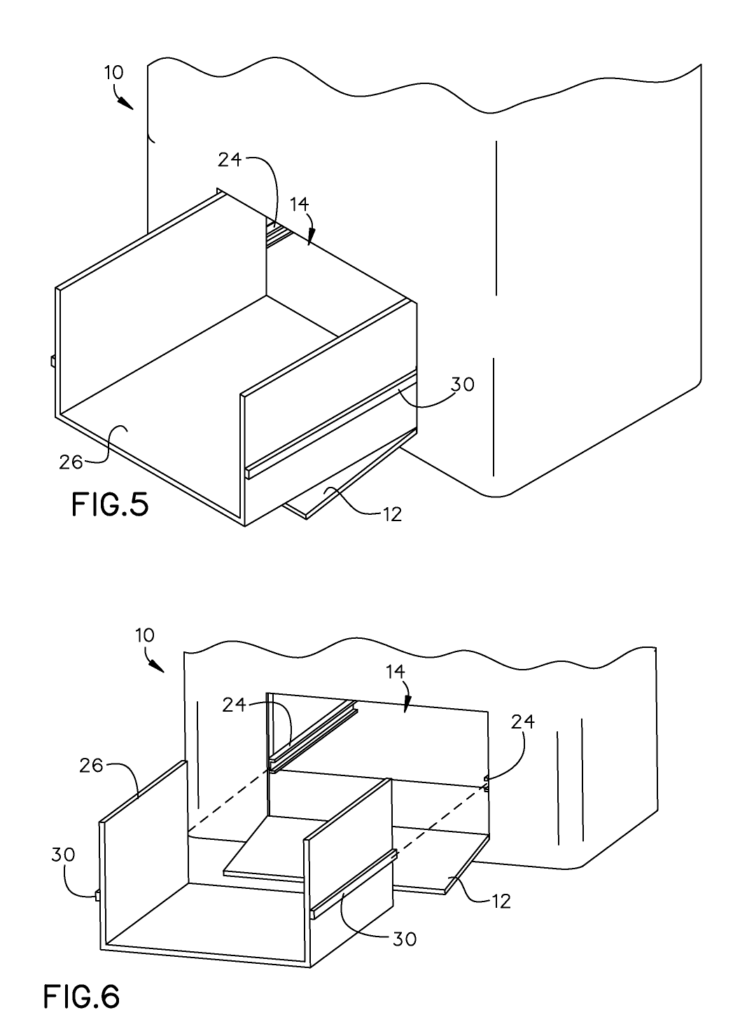

As depicted in FIGS. 5-6, shelf 26 comprises a pair of sliding members 30 affixed to opposing outer edges of the shelf. Bottom compartment 14 comprises a pair of tracks 24 affixed to opposing side walls of the compartment. Sliding members 30 of shelf 26 engage with tracks 24 of bottom compartment 14. This allows shelf 26 to slide to a first position outside trash receptacle 10 and a second position within bottom compartment 14. It shall be appreciated that sliding members 30 and tracks 24 may comprise any components known in the field that allow shelf 26 to slidably adjust with respect to bottom compartment 14.

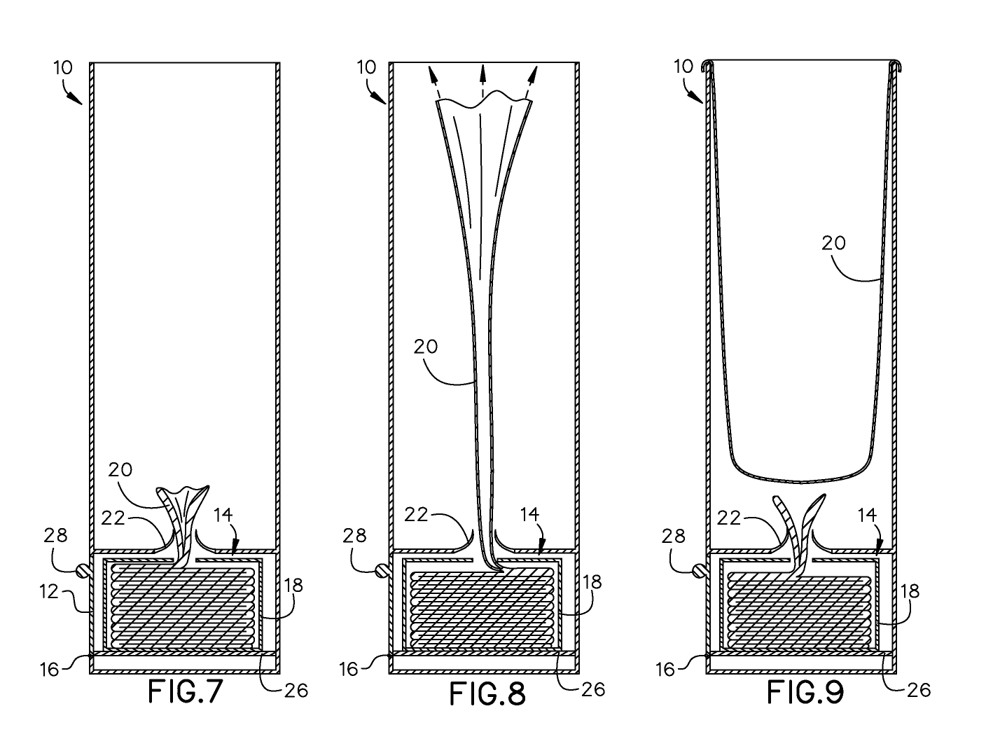

As depicted in FIG. 7, bags 20 are stored within bag storage unit 18. The first bag of the plurality of bags 20 is adjusted to extend through the aperture in bag storage unit 18 and the opening in bottom compartment 14. Rubber flaps 22 hold the first bag 20 in place so that a user can easily reach into trash receptacle 10 to remove a bag for use. As depicted in FIG. 8, a user pulls on the first bag 20 of the plurality of bags upward. The first bag is separated from the remaining bags along a perforation line on the bags. The next bag in the plurality of bags 20 is automatically secured in place by rubber flaps 22. As depicted in FIG. 9, the removed bag 20 is placed within the cavity of trash receptacle 10 to allow for the collection of trash in the bag. Once the removed bag 20 is filled with trash, a user removes the bag from trash receptacle 10 and disposes the waste. This process can be repeated as many times as necessary until all bags 20 stored within bag storage unit 18 are used.

It shall be appreciated that the components of trash receptacle 10 described in several embodiments herein may comprise any known materials in the field and be of any color, size and/or dimensions. For example, the materials of the components may include, but is not limited to, metal, plastic, wood, rubber, or the like. It shall be appreciated that the components of the trash receptacle described herein may be manufactured and assembled using any known techniques in the field.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A trash receptacle configured to store and dispense bags for use with the receptacle to collect trash, the trash receptacle comprising:
a container comprising a cavity and a door pivotably mounted to a front face of the container;
a compartment housed within the bottom portion of the container and comprising a dispensing port on a top face of the compartment;
a shelf slidably mounted to the compartment and configured to adjust to a first position outside of the container when the door is in an open position and a second position within the compartment when the door is in a closed position; and
a storage unit disposed within the shelf and comprising an aperture on a top face of the storage unit, wherein the storage unit is configured to store a plurality of bags to enable a user to remove one of the plurality of bags through the storage unit aperture and the compartment dispensing port for placement within the container cavity, thereby allowing the collection of the trash.

2. The trash receptacle of claim 1, further comprising a plurality of flaps affixed to the dispensing port of the compartment.

3. The trash receptacle of claim 2, wherein the door is pivotably mounted to the container by a pair of spring hinges.

4. The trash receptacle of claim 3, wherein the shelf comprises a pair of sliding members affixed to opposing outer edges of the shelf and the compartment comprises a pair of tracks affixed thereon configured to engage with the pair of sliding members.
